(19) United States
(12) Patent Application Publication
(10) Pub. No.: US 2007/0094456 A1
(43) Pub. Date: Apr. 26, 2007

(54) Storage system and storage control method

(76) Inventors: Yoshinori Matsui, Yokohama (JP); Nobuhiro Maki, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/301,023

(22) Filed: Dec. 13, 2005

(30) Foreign Application Priority Data
Oct. 25, 2005 (JP) 2005-309286

(51) Int. Cl. G06F 13/00

(52) U.S. Cl. 711/154

(57) ABSTRACT

The present invention, when an external device accesses a third storage device in a prescribed environment, increases the likelihood of data in the third storage device being updated in the order in which data in a first storage device is updated, without the need for complex operations by a user.

More specifically, when difference information 13 comprising a data group, which represents differences between a data group inside a P-storage device 10P and a data group inside an SP-storage device 11SP, is transmitted, a first storage subsystem 5 sends an interrupt command and a restart command such that the difference information 13 is interposed therebetween, and a third storage subsystem 7 receives the interrupt command and restart command by way of a second storage subsystem 6, and based on these commands, writes the data group inside the difference information 13 to an S-storage device 12S.

### CROSS-REFERENCE TO PRIOR APPLICATION

This application relates to and claims priority from Japanese Patent Application No. 2005-309286, filed on Oct. 25, 2005 the entire disclosure of which is incorporated herein by reference.

### BACKGROUND OF THE INVENTION

1. Field of the Invention

The present invention relates to storage control technology, and more particularly to the restoration of data using remote copying.

2. Description of the Related Art

A storage system comprising a plurality of storage subsystems is known. As such a storage system, for example, there is the system disclosed in Japanese Laid-open Patent No. 2003-122509. In Japanese Laid-open Patent No. 2003-122509, for example, the following is disclosed.

(1) A first storage subsystem is connected to a second storage subsystem, and the second storage subsystem is connected to a third storage subsystem. Synchronous-type remote copying is carried out between the first storage subsystem and the second storage subsystem, and asynchronous-type remote copying is carried out between the second storage subsystem and the third storage subsystem. In an asynchronous-type remote copy, when data is updated in the second storage subsystem, data is transferred from the second storage subsystem to the third storage subsystem.

(2) Further, it is disclosed that differences in the data stored among the storage subsystems is managed, making it possible to restore data by using this difference data.

### SUMMARY OF THE INVENTION

Now then, for example, it is supposed that a first storage subsystem comprises a first storage device. It is supposed that a second storage subsystem comprises a second storage device. It is supposed that a third storage subsystem comprises a third storage device. It is supposed that data written to the first storage device is also written to the second storage device by remote copying. It is supposed that data written to the second storage device is written to the third storage device by remote copying. It is supposed that a device, which is outside the storage system (hereinafter, external device), is constituted so as to be able to access the first storage device and the third storage device.

In other words, in this environment, when a data update is generated in the first storage device, this dynamic sequentially generates data updating synchronously and asynchronously in the second storage device and third storage device. When the external device accesses the third storage device, it is desirable to guarantee that the updating of data in the third storage device is carried out in the order in which data in the first storage device is updated. However, the problem is that requiring a user to perform a complicated operation in order to do so increases the likelihood of an erroneous operation being performed.

Therefore, an object of the present invention, in an environment in which data written to a first storage device is transferred from a first storage subsystem to a second storage subsystem and written to a second storage device, and data written to the second storage device is transferred from the second storage subsystem to a third storage subsystem and written to a third storage device, is to increase the likelihood that data in the third storage device is updated in the order in which the data in the first storage device is updated when the external device accesses the third storage device, without the need for a user to perform a complicated operation.

Other objects of the present invention should become clear from the following explanation.

A storage control method according to a first aspect of the present invention is a storage control method implemented in a storage system comprising a first storage subsystem; a second storage subsystem, which is communicatively connected to the above-mentioned first storage subsystem; and a third storage subsystem, which is communicatively connected to the above-mentioned second storage subsystem. When a difference data group that is being held is to be sent, this storage control method controls the reflection of the difference data group in the third storage device of the third storage subsystem by virtue of the first storage subsystem sending a first information and a second information such that the difference data group is sandwiched therebetween. A more detailed explanation is as follows.

The above-mentioned first storage subsystem comprises a first storage device, and is communicatively connected to an external device, which lies outside the above-mentioned storage system. The above-mentioned second storage subsystem comprises a second storage device, and a first journal storage device capable of storing a journal group. The above-mentioned third storage subsystem comprises a third storage device, and a second journal storage device. The environment is such that data written to the first storage device is transferred from the first storage subsystem to the second storage subsystem and written to the second storage device, and data written to the second storage device is transferred from the second storage subsystem to the third storage subsystem and written to the third storage device.

When the above-mentioned first storage subsystem does not send data, which is written to the above-mentioned first storage device, to the above-mentioned second storage subsystem, and new data is written to the above-mentioned first storage device, this newly written data is held as difference data, which is the difference between a data group inside the above-mentioned first storage device and a data group inside the above-mentioned second storage device, and when a difference data group comprising one or more difference data is sent to the above-mentioned second storage subsystem, a first information and a second information are sent to the above-mentioned second storage subsystem such that the above-mentioned difference data group is interposed therebetween.

The above-mentioned second storage subsystem receives the above-mentioned first information, the above-mentioned difference data group, and the above-mentioned second information, writes the above-mentioned received difference data group to the above-mentioned second storage device, writes a difference journal group, which is one or more journals comprising the above-mentioned difference data group, to the above-mentioned first journal storage device, and sends the above-mentioned first information, the above-mentioned difference journal group, and the above-mentioned second information to the above-mentioned third storage subsystem.

The above-mentioned third storage subsystem receives the above-mentioned first information, the above-mentioned difference journal group, and the above-mentioned second information, writes the above-mentioned difference journal group to the above-mentioned second journal storage device, and, on the basis of the above-mentioned first information and the above-mentioned second information, writes the above-mentioned difference data group, which is included in the above-mentioned difference journal group inside the above-mentioned second journal storage device, to the above-mentioned third storage device.

In the first aspect of the present invention, the above-mentioned third storage subsystem can carry out exclusive control such that the above-mentioned third storage device is not accessed by either the above-mentioned external device or the above-mentioned other external device, at the least while it is writing the above-mentioned difference data group inside the above-mentioned difference journal group to the above-mentioned third storage device.

An external device, for example, can be a computer or a storage subsystem. Various types of computers can be employed as a computer, such as a host computer, or a maintenance terminal for carrying out maintenance on a storage subsystem.

In a second aspect of the present invention, the above-mentioned first storage subsystem can send the above-mentioned first information, the above-mentioned difference data group, and the above-mentioned second information, in that order, to the above-mentioned second storage subsystem. The above-mentioned second storage subsystem can create a journal group, which represents the order of the above-mentioned first information, the above-mentioned difference journal group, and the above-mentioned second information. The above-mentioned third storage subsystem, based on the above-mentioned journal group, can recognize the above-mentioned first information prior to recognizing the above-mentioned difference journal group and the above-mentioned second information. In this case, when the above-mentioned third storage subsystem recognizes the above-mentioned first information, it can search for the above-mentioned second information, which exists separate from the difference journal group, and when it finds the above-mentioned second information, it can continuously write the above-mentioned difference data group inside the above-mentioned difference journal group to the above-mentioned third storage device without a substantial lapse of time.

In a third aspect of the present invention, the above-mentioned first storage subsystem comprises a difference bitmap having a plurality of bits respectively corresponding to a plurality of storage areas of the above-mentioned first storage device, and can be constituted such that, when data is written to a certain storage area of the above-mentioned first storage device, a bit corresponding to the above-mentioned certain storage area is updated, and when new data is again written to the above-mentioned certain storage area, the updated bit of the above-mentioned certain storage area is not updated.

In a fourth aspect of the present invention, when data written to the above-mentioned first storage device is not sent to the above-mentioned second storage subsystem, it can be supposed that, either communication is not possible between the above-mentioned first storage subsystem and the above-mentioned second storage subsystem, or the state of a copy group comprising the above-mentioned first storage device and the above-mentioned second storage device was changed to a prescribed state.

In a fifth aspect of the present invention, in the above-mentioned environment, the above-mentioned first storage subsystem can receive data from the above-mentioned external device, write the received data to the above-mentioned first storage device, and send the above-mentioned data, which is written to the above-mentioned first storage device, to the above-mentioned second storage subsystem. Further, the above-mentioned second storage subsystem can receive data from the above-mentioned first storage subsystem, write the above-mentioned received data to the above-mentioned second storage device, write a journal comprising the above-mentioned received data, and the order, in which the above-mentioned received data was written to the above-mentioned second storage device, to the above-mentioned first journal storage device, and send the respective journals of the journal group inside the above-mentioned first journal storage device to the above-mentioned third storage subsystem. Further, the above-mentioned third storage subsystem can receive the respective journals from the above-mentioned second storage subsystem, write the above-mentioned received respective journals to the above-mentioned second journal storage device, acquire journals, in the above-mentioned order from the most recent to the oldest, from among the journal group inside the above-mentioned second journal storage device, and write the data inside the above-mentioned acquired journals to the above-mentioned third storage device.

The respective processes carried out by the respective storage subsystems described hereinabove can be achieved by various means. The various means can be achieved via hardware circuits, computer programs, or a combination thereof.

### BRIEF DESCRIPTION OF THE DRAWINGS

FIG. 1 is a diagram showing an overview of a storage system related to one embodiment of the present invention;

FIG. 2 shows an example of the configuration of a computer 1 related to one embodiment of the present invention;

FIG. 3 is a diagram showing respective examples of the configurations of a first storage subsystem 5 and a second storage subsystem 6;

FIG. 4 is a diagram showing an example of information stored in a control memory 318 provided in a first storage subsystem 5;

FIG. 5 is a diagram showing an example of information comprising copy group information 421;

FIG. 6 is a diagram showing an example of information comprising journal management information 422;

FIG. 7 is a diagram showing an example of information comprising a journal 320;

FIG. 8 is an example of a flowchart of processing carried out by the first storage subsystem 5 when a resynchronization operation is received from the computer 1;

FIG. 9 shows an example of a flowchart of processing carried out by the second storage subsystem 6 when information is received from the first storage subsystem 5; and

FIG. 10 shows an example of a flowchart of a restoration carried out by a third storage subsystem 7.

### DESCRIPTION OF THE PREFERRED EMBODIMENT

A storage system related to one embodiment of the present invention will be explained below using the FIGS.

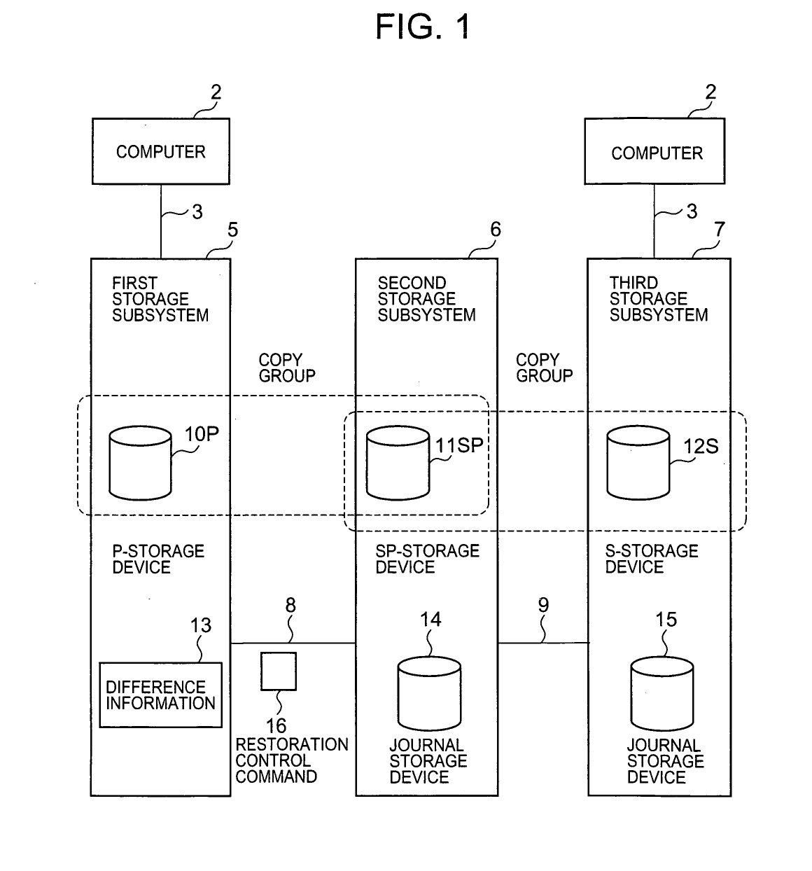

FIG. 1 is a diagram showing an overview of a storage system related to one embodiment of the present invention.

A storage system related to this embodiment comprises a first storage subsystem 5, a second storage subsystem 6, and a third storage subsystem 7. A computer 1 is communicatively connected to the first storage subsystem 5 via a path 3, and the second storage subsystem 6 is communicatively connected to the first storage subsystem 5 via a path 8. The third storage subsystem 7 is communicatively connected to the second storage subsystem 6 via a path 9. A computer 2 is communicatively connected to the third storage subsystem 7 via a path 4. The paths 3, 8, 9, and 4 can be provided by dedicated lines and communications networks. Further, the respective computers 1, 2 can be communicatively connected to all of the storage subsystems 5 through 7.

The respective storage subsystems 5 through 7 comprise at the least one storage device. More specifically, for example, the first through the third storage subsystems 5 through 7 respectively comprise a first through a third storage device. Then, a first copy group, which comprises the first storage device and the second storage device, and a second copy group, which comprises the second storage device and the third storage device, are respectively formed. For the first copy group, data written to the first storage device is written to the second storage device by remote copying. For the second copy group, data written to the second storage device is written to the third storage device by remote copying. Below, the storage device, which constitutes the copy source in a copy group will be called the “P-storage device”, an abbreviation for primary storage device, and the storage device, which constitutes the copy destination in a copy group will be called the “S-storage device”, an abbreviation for secondary storage device. Thus, hereinbelow the first storage device is described as the “P-storage device 10P” and the third storage device is described as the “S-storage device 12S”. Further, because the second storage device can constitute both a copy source and a copy destination, it is described as the “SP-storage device 11SP”. The respective storage devices 10P, 11SP, 12S can be considered to be the same storage capacity, respectively. Further, in this embodiment, the constitution is such that the computer 1 can access the P-storage device 10P, and the computer 2 can access the S-storage device 12S.

Synchronous remote copying is carried out for the first copy group. Synchronous remote copying refers to the fact that at the same timing (substantially the same timing) that data is written to the P-storage device 10P, a write request comprising this data is sent from the first storage subsystem 5 to the second storage subsystem 6, and written to the SP-storage device 11SP. More specifically, for example, when the first storage subsystem receives a data write request for the P-storage device 10P, it writes the data in this write request to a cache memory not shown in the figure and to the P-storage device 10P, and sends a remote copy request, for writing this data to the SP-storage device 11SP, to the second storage subsystem 6, and thereafter, it can return a prescribed completion notification (for example, a write complete notification) to the computer 1, with or without receiving predetermined responses (for example, a response signifying that data has been received, and a response signifying that data has been written to the SP-storage device 11SP) from the second storage subsystem 6.

Conversely, asynchronous remote copying is carried out for the second copy group. Asynchronous remote copying refers to the fact that data is transferred from the second storage subsystem 6 to the third storage subsystem 7 at a timing, which differs from that at which this data is written to the SP-storage device 11SP and to the S-storage device 12S. For asynchronous remote copying, since the transfer of data to the third storage subsystem is not synchronized with the timing at which this data is written to the SP-storage device 11SP, it becomes necessary to manage the order in which data is updated in the SP-storage device 11SP. For this reason, journal storage devices 14, 15 are respectively provided in the second and third storage subsystems 6 and 7. When the second storage subsystem 6 receives a remote copy request for the SP-storage device 11SP, it can write the data in this request to the SP-storage device 11SP, generate update log information comprising this data (hereinafter, this will be referred to as a “journal”), and write this journal to the journal storage device 14. The journal, for example, in addition to data, comprises an information element (for example, a logical block address (LBA)) representing the location to which this data was written, and an information element for determining what number update this data was (for example, the time and order in which this data was written to the SP-storage device 11SP). The second storage subsystem 6 can send a journal of inside the journal storage device 14 to the third storage subsystem 7 at a timing that is not synchronized with the writing of data to the SP-storage device 11SP. The second storage subsystem 6 can actively send a journal, and it can also send a journal in response to a request (for example, a read request) from the third storage subsystem 7.

When the third storage subsystem 7 receives a journal from the second storage subsystem 6, it writes the received journal to the journal storage device 15. Then, the third storage subsystem 7 writes the data inside the journal to a location in the S-storage device 12S specified from this journal, at a prescribed timing, and in order from the journal, which is the most recent in the update order from among a plurality of journals inside the journal storage device 15. This restores the data in the S-storage device 12S.

In accordance with a constitution such as that described hereinabove, the data of the S-storage device 12S can be updated in the order in which data is updated in the P-storage device 10P.

Now then, in this embodiment, when you want to make the data group inside the SP-storage device 11SP the same as the data group inside the P-storage device 10p, it is likely that a state (hereinafter, synchronous-copy-not-possible state) will occur in which it will not be possible to do this because the data in the P-storage device 10P was not transferred to the second storage subsystem 6. Reasons why a synchronous-copy-not-possible state occurs include an obstacle in the path 8, and the state of the first copy group being a suspended state, which will be explained hereinafter. In a state such as this, when the data of the P-storage device 10P is updated, a difference occurs between the data group inside the P-storage device 10P and the data group inside the SP-storage device 11SP.

When it becomes at the least a synchronous-copy-not-possible state, in other words, when it becomes a state, wherein the above-mentioned difference occurs, the first storage subsystem 5 can manage this difference.

More specifically, for example, the first storage subsystem 5 comprises a bitmap (hereinafter, difference bitmap) comprising a plurality of bits respectively corresponding to a plurality of storage areas of the P-storage device 10P, and can utilize this difference bitmap to manage a data difference. More specifically, for example, when new data is written to respective locations of the P-storage device 10P, the first storage subsystem 5 can update the bits corresponding to these respective locations (At this time, for example, when the first storage subsystem 5 writes new data once again to the same location as the location corresponding to an updated bit, this bit will not be updated). As a result of this, the data in the locations corresponding to the updated bits constitute the difference between the data group inside the P-storage device 10P and the data group inside the SP-storage device 11SP (hereinafter, difference data). Furthermore, the respective difference data can be stored in a storage resource other than the P-storage device 10P (for example, a memory inside the first storage subsystem 5). In this embodiment, information comprising the difference bitmap and the respective difference data is treated as difference information 13. The first storage subsystem 5 can also comprise information representing which difference data corresponds to which bits.

Incidentally, when managing a plurality of difference data using the difference bitmap, the order in which difference data is generated is not managed. In other words, the order in which difference data occurs is not guaranteed.

When the synchronous-copy-not-possible state is cancelled by a state, wherein a plurality of difference data exists in the first storage subsystem 5, and, for example, a resynchronization (hereinafter, resynch) operation is performed for a first copy group in order to make the data group inside the P-storage device lop and the data group inside the SP-storage device 11SP the same, the first storage subsystem 5 can transfer the plurality of difference data to the second storage subsystem 6. Thus, the plurality of journals comprising the plurality of difference data, respectively, is stored in the journal storage device 14.

However, the state is such that the order in which this plurality of difference data is generated is not guaranteed, and the second storage subsystem and third storage subsystem are communicatively connected. Thus, a plurality of journals respectively comprising a plurality of difference data, the orderability of which is not guaranteed, is respectively sent to the third storage subsystem 7, and, in this unguaranteed order (that is, an order, which differs from the order occurring in the P-storage device 10P), the journals are utilized to carry out restoration. As a result of this, a state, wherein the data updating order is not guaranteed, occurs in the S-storage device 12S. It is possible that the S-storage device 12S will be accessed from the computer 2 while in this state.

A method for preventing this is to have the users of the computers 1 and 2 execute a plurality of operations in a prescribed sequence. More specifically, for example, there is a method, whereby, after executing a suspend operation for setting the state of the second copy group to the hereinafter-explained suspended state, a user executes a resynch operation relative to the first copy group, and, in addition, performs an operation for establishing data, the orderability of which at a desired point in time is guaranteed, in the S-storage device 12S.

However, with this method, an erroneous operation is likely to occur, therefore making it difficult to prevent the computer 2 from accessing the S-storage device 12S in a state, wherein the data updating order is not guaranteed by the S-storage device 12S.

Accordingly, in this embodiment, the above-mentioned situation can be prevented using the following measures, without requiring that a user perform complicated operations. These measures will be explained hereinbelow.

The first storage subsystem 5 can send a command (hereinafter, restoration control command) 16 for controlling restoration execution. More specifically, for example, when the first storage subsystem 5 sends a plurality of difference data to the second storage subsystem 6 (for example, when it receives a resynch command for the first copy group), it sends a restoration interrupt command (a restoration control command 16 signifying the interruption of restoration) to the second storage subsystem 6, and sends the plurality of difference data thereafter. After the first storage subsystem 5 finishes sending the plurality of difference data, it can send a restoration restart command (a restoration control command 16 signifying the restart of restoration) to the second storage subsystem 6.

This makes it possible for the second storage subsystem 6, after receiving a restoration interrupt command, to receive a plurality of difference data, and thereafter, to receive a restoration restart command. The second storage subsystem 6 can write the plurality of difference data to the SP-storage device 11SP, and can write a plurality of journals respectively comprising the plurality of difference data (hereinafter, difference journals) to the journal storage device 14. The second storage subsystem 6 sends a restoration interrupt command, the plurality of difference data, and a restoration restart command, in that order, to the third storage subsystem 7.

The third storage subsystem 7 can restore the plurality of difference data respectively included in the plurality of difference journals in the S-storage device 12S on the basis of the restoration interrupt command and restoration restart command. More specifically, for example, the third storage subsystem 7 writes the restoration interrupt command, the plurality of difference journals, and the restoration restart command to the second journal storage device 15, and when it references the restoration interrupt command from the second journal storage device 15, it searches for the restoration restart command, and when it finds the restoration restart command, it can continuously (in other words, in a single burst) execute restoration based on the plurality of difference journals that exist between the restoration interrupt command and the restoration restart command, without a substantial lapse of time. Further, the third storage subsystem 7 can execute exclusive control so that the S-storage device 12S is not accessed from the computer 2 at the least while restoration is being executed on the basis of the plurality of difference journals. Exclusive control can be carried out via various methods (for example, refusing access when accessed from an external device). The third storage subsystem 7 can halt exclusive control after restoration based on the plurality of difference journals is complete (That is, it can allow access to the S-storage device 12S from the computer 2).

In accordance with this embodiment, a restoration interrupt command is issued prior to a plurality of difference data being sent, and a restoration restart command is issued after the plurality of difference data is finished being sent. As a result, in the third storage subsystem 7, a restoration interrupt command is recognized and exclusive control of access to the S-storage device 12S from the computer 2 is commenced before an exception restoration is executed, and a restoration restart command is recognized and the above-mentioned exclusive control is cancelled after the exception restoration has been completed. This can prevent the S-storage device 12S from being accessed from the computer 2 in a state, wherein the data updating order is not guaranteed, without requiring that a user carry out a complicated operation.

Furthermore, in the above embodiment, the first storage subsystem 5 can send difference information 13. In this case, the second storage subsystem 6 can write a plurality of difference data to the SP-storage device 11SP using a difference bitmap.

A specific example of this embodiment will be explained hereinbelow.

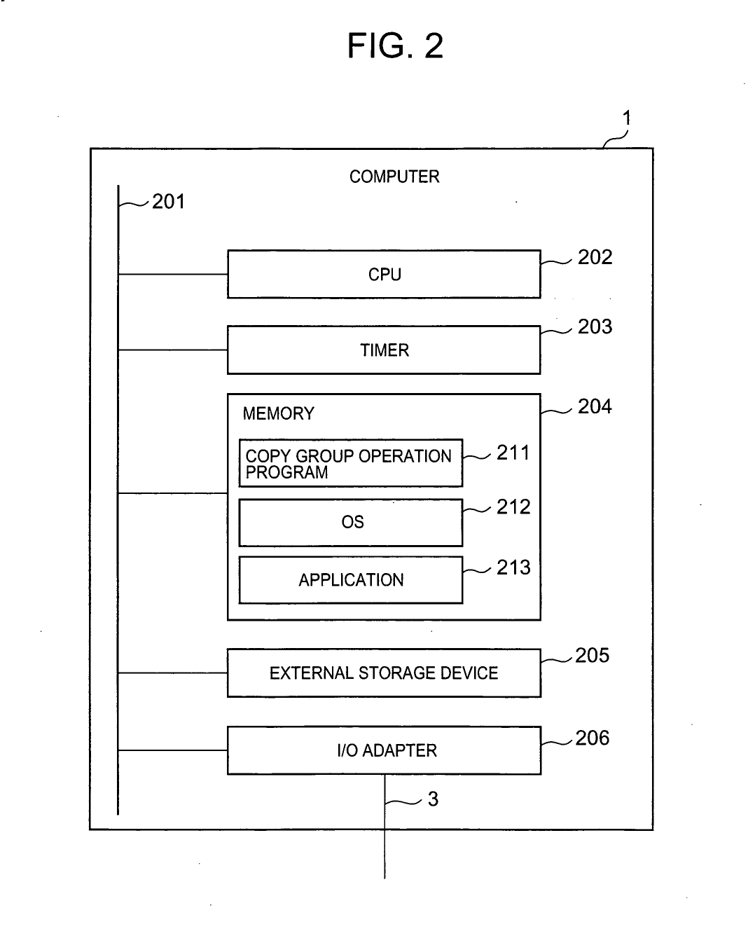

FIG. 2 shows an example of a configuration of a computer 1 related to one embodiment of the present invention. Since the configuration example of the computer 1 can also be applied to the computer 2, the computer 1 will be explained below as a typical example.

The computer 1 comprises a CPU 202; timer 203; memory 204; external storage device 205; I/O adapter 206; and an internal path 201 interconnecting these.

The CPU 202 is a processor for controlling the computer 1. The CPU 202 can read and execute various programs stored in the memory 204.

The timer 203 is a device for managing the timing of the computer 1.

The memory 204, for example, stores a copy group operation program 211, an operating system (OS) 212, and an application program (hereinafter, application) 213.

The copy group operation program 211 is one type of application, which runs on the OS 212, and can utilize the functionality of the OS 212 to issue an I/O request to the first storage subsystem 5. The I/O request issued here, for example, is an operation command for manipulating a copy group. Manipulating a copy group can change the state of the copy group. The states of a copy group, for example, are a combined state, a non-combined state, a suspended state, and a transitional state.

A combined state is a state, wherein the primary storage device and secondary storage device for a copy group are duplexed. Here, a primary storage device is a copy source storage device. A secondary storage device is a copy destination storage device. For a copy group in the combined state, when data is written to a primary storage device, this data is also written, at practically the same timing, to a secondary storage device.

The non-combined state is a state, wherein the primary storage device and secondary storage device for a copy group are not duplexed. When a copy group is in the non-combined state, even if data is written to a primary storage device, this data is not written to a secondary storage device.

The suspended state is a state, wherein the duplexed association between a primary storage device and a secondary storage device is temporarily suspended. When a copy group is in the suspended state, if the first storage subsystem 5 carries out a data write to a primary storage device, this data can be stored as difference data in a prescribed storage region (for example, in memory or a separate storage device). Later, when a resynch operation is carried out for a copy group in the suspended state, the first storage subsystem 5 can reflect the difference information 13 (and the difference data inside this information 13) to a secondary storage device via remote copying.

The OS 212 can issue an I/O request to the first storage subsystem 5 in accordance with a copy group operation program 211, application 213 or other such request.

The application 213 is a program, which runs on the OS 212. Further, even when the copy group operation program 211 is running, another application 213 can also run.

The external storage device 205 is a storage device (for example, a hard disk drive), which can store the programs needed to operate the computer 1. Any external storage device 205 is fine as long as the OS 212 can recognize it.

The I/O adapter 206 is a kind of interface device, which can control communications with the first storage subsystem 5. An I/O request issued by the OS 212 is sent to the first storage subsystem 5 by way of the internal path 201 and the I/O adapter 206 via a path 3.

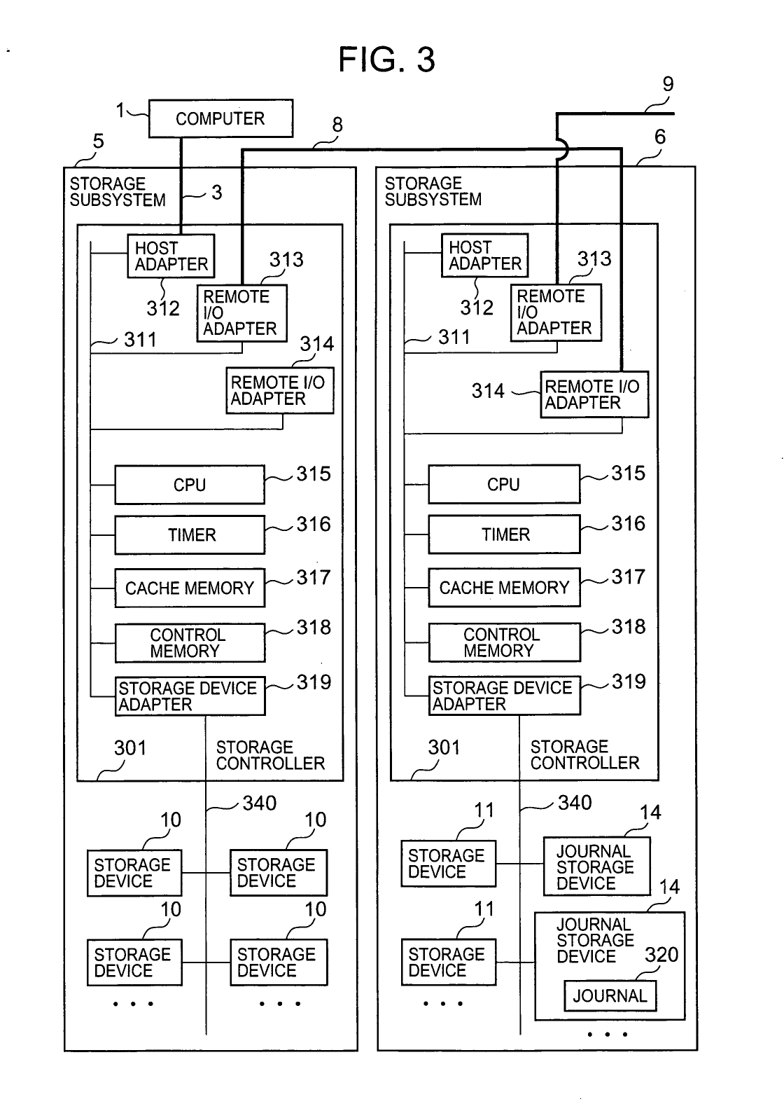

FIG. 3 is a diagram showing examples of the respective configurations of the first storage subsystem 5 and the second storage subsystem 6. Furthermore, since the configuration example for the first storage subsystem 5 can be applied to the second and third storage subsystems 6 and 7, the configuration example for the first storage subsystem 5 will be used as the example and explained hereinbelow.

The first storage subsystem 5 comprises a storage controller 301, a plurality of storage devices 10, and an internal path 340 interconnecting these.

The storage controller 301 is the member, which exercises control in accordance with an I/O request from the computer 1 or another storage subsystem. The storage controller 301, for example, can comprise a host adapter 312; a remote I/O adapter 313; a remote I/O adapter 314; a CPU 315; a timer 316; a cache memory 317; a control memory 318; a storage device adapter 319; and an internal path 311 interconnecting these.

The host adapter 312 is the member, which receives an I/O request from the computer 1 for the first storage subsystem 5. The types of I/O requests that the respective storage subsystems 5, 6, 7 are capable of receiving are a write request for writing data to a storage device, a read request for reading data from a storage device, an operation command for manipulating a copy group, and a restoration control command 16.

The remote I/O adapter 313 and remote I/O adapter 314 are devices for carrying out communications with other storage subsystems. Of these, the remote I/O adapter 313 can be used for sending data, and the remote I/O adapter 314 can be used for receiving data. The sending remote I/O adapter 313 is connected to the receiving remote I/O adapter 314 in another storage subsystem via a path 8. Connecting the sending remote I/O adapter 313 of the second storage subsystem 6 to the receiving remote I/O adapter 314 of the first storage subsystem 5 enables reverse communications, that is, it makes it possible to send data from the second storage subsystem 6 to the first storage subsystem 5. Further, the remote I/O adapters for sending and receiving can also be integrated.

The CPU 315 is a processor for controlling the entire storage controller 301.

The timer 316 is a device for managing the timing of the storage controller 301.

Cache memory 317 is a storage area capable of temporarily storing data, which either is to be written to a storage device 10, or was read from a storage device 10.

Control memory 318 is a storage area, which is used when the storage controller 301 is controlling the first storage subsystem 5. A detailed explanation will be provided hereinafter, but the control memory 318, for example, can store a program for controlling data read/write, a program for manipulating a copy group, a program for controlling restoration in accordance with a restoration control command 16, and information referenced by these programs.

The storage device adapter 319 is a device for carrying out communications with a storage device 10. Data inside a storage device 10 is sent to the computer 1 or another storage subsystem (in FIG. 2, the second storage subsystem 6) via the internal path 340, the storage device adapter 319, and either the host adapter 312 or the sending remote I/O adapter 313. Data is also received from the computer 1 or another storage subsystem via the same route.

The foregoing is an explanation of an example of the configuration of the first storage subsystem 5. Furthermore, although not required in the first storage subsystem 5, the second storage subsystem 6 comprises a journal storage device 14 (The same holds true for the third storage subsystem 7.). The journal storage device 14 can store a journal 320.

Furthermore, in the foregoing explanation, a storage device can be either a physical storage device or a logical storage device. As a physical storage device, for example, a disk-type storage device (for example, a hard disk drive) can be employed. As a logical storage device, for example, a logical unit disposed on one or more physical storage devices (also called a logical volume or logical device) can be employed.

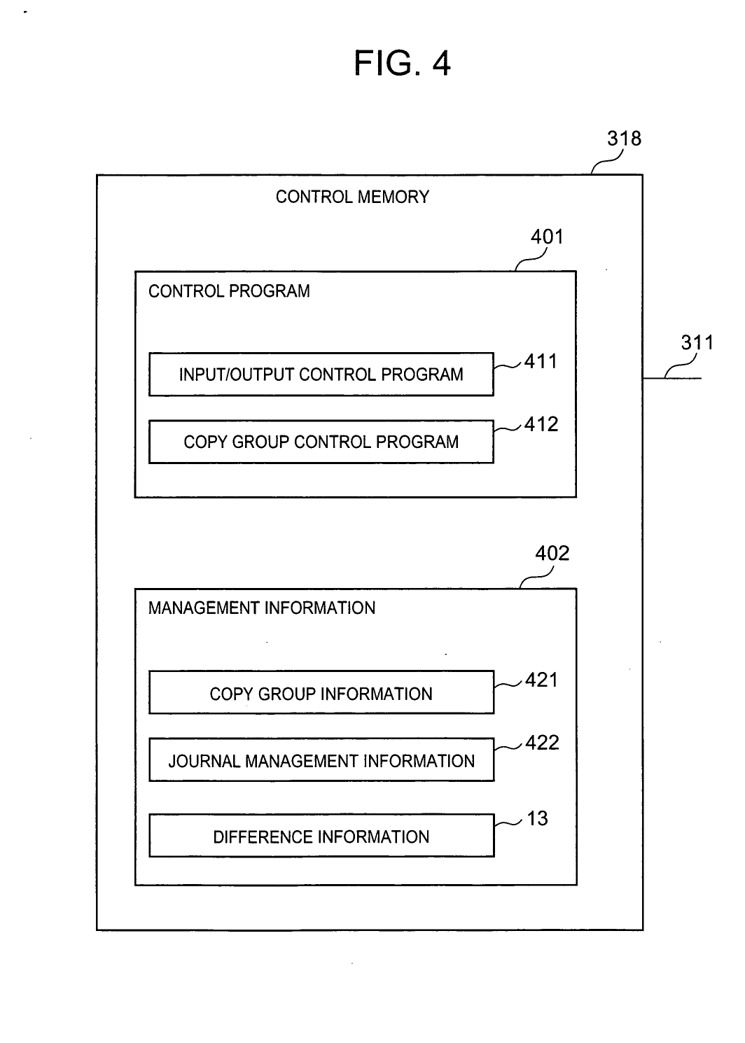

FIG. 4 is a diagram showing an example of information, which is stored in the control memory 318 comprising the first storage subsystem 5. Substantially the same information as the information stored in the control memory 318 shown in FIG. 4 can also be stored in a control memory 318 comprising the second storage subsystem 6 and the third storage subsystem 7.

The control memory 318 stores a control program 401 and management information 402.

The control program 401 is a variety of programs for controlling the first storage subsystem 5. The control program 401, for example, comprises an input/output control program 411, which controls a write request and a read request from the computer 1 to a storage device 10, and a copy group control program 412, which controls a copy group.

Management information 402 comprises information, which is referenced by various programs. Management information 402, for example, comprises copy group information 421, journal management information 422, and difference information 13. Journal management information 422 exists in the second storage subsystem 6 and the third storage subsystem 7, and does not have to exist in the first storage subsystem 5. Difference information 13 exists in the first storage subsystem 5 and the second storage subsystem 6, and does not have to exist in the third storage subsystem 7.

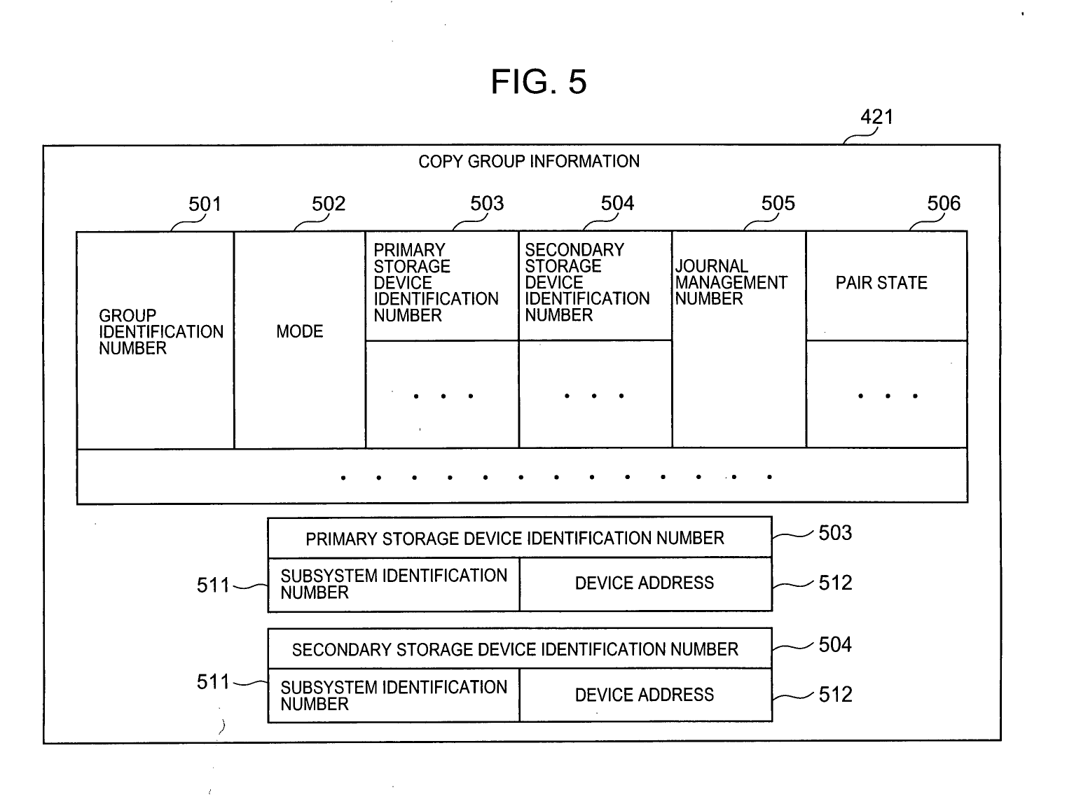

FIG. 5 is a diagram showing an example of information comprising copy group information 421.

Copy group information 421 comprises the respective entries corresponding to the respective copy groups. Each entry, for example, comprises a group identification number 501, a mode 502, a primary storage device identification number 503, a secondary storage device identification number 504, a journal identification number 505, and a pair state 506.

The group identification number 501 is a number, which uniquely identifies a copy group.

The mode 502 is information indicating the copying method. Information denoting this copying method, for example, includes information such as whether the primary storage device and secondary storage device are synchronous or asynchronous, whether copying utilized a journal, whether it is a copy inside the same storage device or a copy from another storage device. As a concrete example of this embodiment, the mode 502 of a copy group comprising a P-storage device lop and an SP-storage device 11SP is “synchronous”, and the mode 502 of a copy group comprising a SP-storage device 11SP and a S-storage device 12S is “asynchronous”.

The primary storage device identification number 503 is information, which uniquely identifies the primary storage device of a copy group.

The secondary storage device identification number 504 is information, which uniquely identifies the secondary storage device corresponding to the primary storage device identification number 503.

The journal management number 505 is information, which is associated to hereinafter-explained journal management information 422 (for example, an identification number 601 for journal management information 422), and is set when a copy utilizes a journal (in other words, for an asynchronous-type remote copy).

A subsystem identification number 511 and a device address 512 correspond to a primary storage device identification number 503 and a secondary storage device identification number 504, respectively. The subsystem identification number 511 is a number for uniquely identifying the storage subsystem comprising a storage device, and, for example, corresponds to a serial number or manufacturer's number. The device address 512 corresponds to an address (for example, a Logical Unit Number (LUN)) for uniquely identifying a storage device inside a storage subsystem.

A pair state 506 expresses the state of a copy group, and, for example, can be a combined state, a not-combined state, a suspended state, and a transitional state.

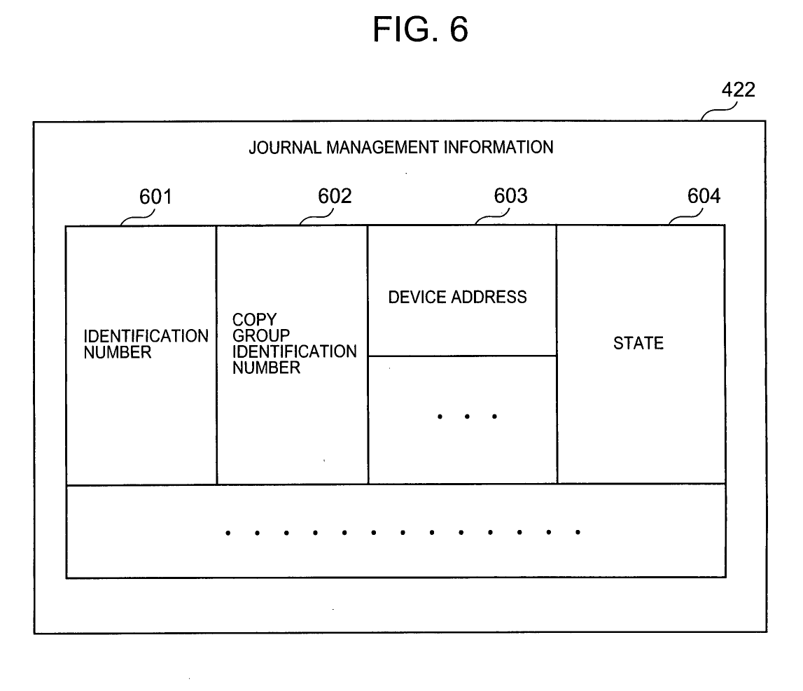

FIG. 6 is a diagram showing an example of the information comprising journal management information 422.

Journal management information 422 comprises a plurality of entries, and each entry comprises an identification number 601, a copy group identification number 602, a device address 603, and a state 604.

The identification number 601 is information, which identifies an entry. A group identification number 501 is set in the copy group identification number 602, thereby associating journal management information 422 and copy group information 421. The device address 603 is information, which denotes the address of journal storage device 14 or 15. The state 604 is information indicating whether storage device 11 or 12 is implementing or suspending journal restoration.

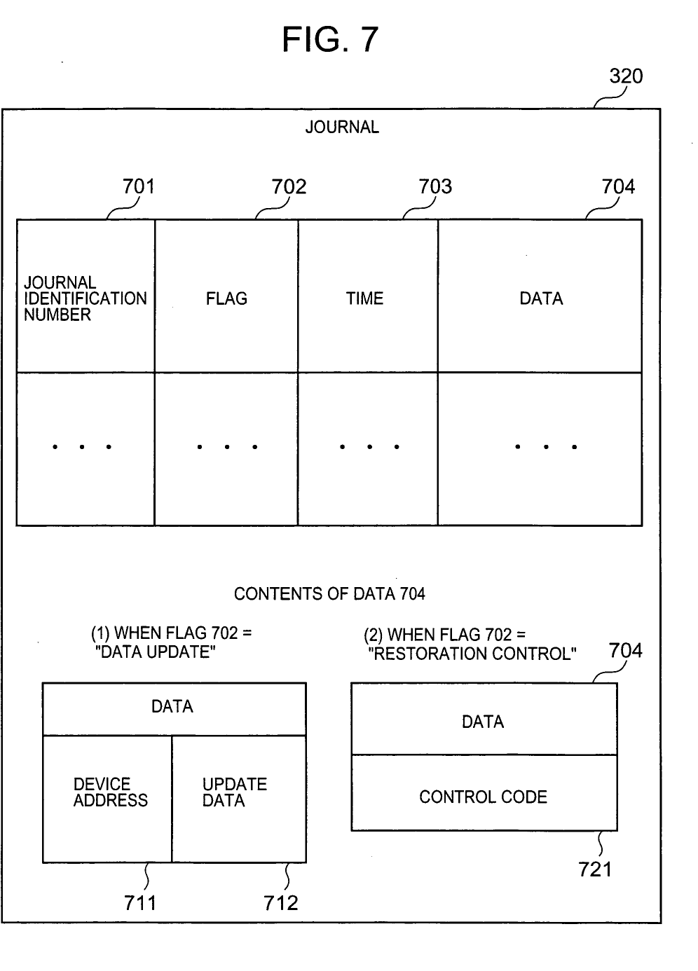

FIG. 7 is a diagram showing an example of the information comprising a journal 320.

A journal identification number 701, a flag 702, a time 703, and data 704 are recorded in a journal 320.

The journal identification number 701 is information, which uniquely identifies a journal 320. The flag 702 is information, which determines whether data 704 comprising a journal 320 is data that has been written to a storage device (hereinafter “data update”), or a restoration control command (hereinafter, “restoration control”). The time 703 denotes the time at which an I/O request was issued (For example, the time it was issued from the computer 1 or the first storage subsystem 5). The data 704 is information, which differs according to the information indicated by the flag 702. When the flag 702 is “data update”, the data 704 comprises a device address 711 (for example, the identification number of the S-storage device 12S), and update data 712 (for example, data written to the SP-storage device 11SP). When the flag 702 is “restoration control”, the data 704 comprises a control code 721. This control code 721 comprises a code, which signifies “interrupt”, and a code, which signifies “restart”.

An example of the flow of the various processing carried out in a concrete example of this embodiment will be explained hereinbelow.

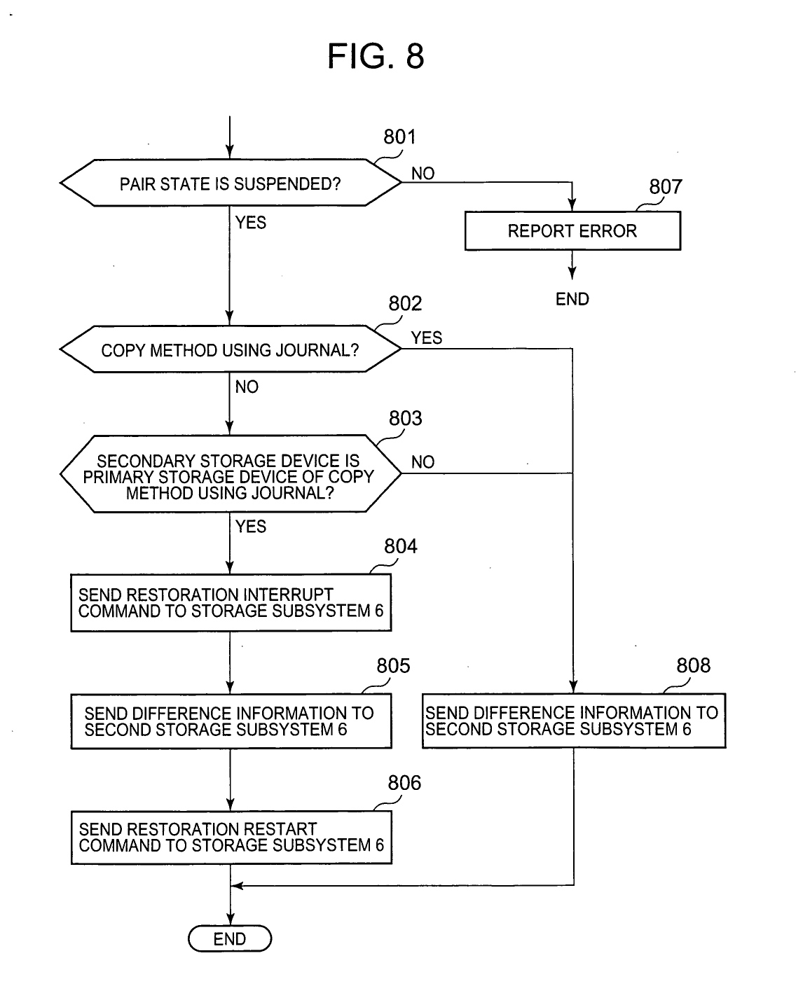

FIG. 8 is an example of a flowchart of processing carried out by the first storage subsystem 5 upon receiving a resynch operation from the computer 1.

The first storage subsystem 5 (especially, the storage controller 301) detects, from among the copy group information 421, a copy group entry, which is targeted for a resynch operation, and makes a determination as to whether or not the pair state 506 in this entry is a suspended state (Step 801). When an affirmative determination result is obtained in Step 801 (Step 801: YES), the first storage subsystem 5 references the mode 502 of the above-mentioned detected entry, and makes a determination as to whether or not the copy group targeted for the resynch operation employed a copying method, which utilized a journal (Step 802).

When a negative determination result is obtained in Step 802 (Step 802: NO), the first storage subsystem 5 makes determinations as to whether or not the secondary storage device of the copy group targeted for the resynch operation is the primary storage device of another copy group, and as to whether or not a copying method utilizing a journal was employed in this other copy group (Step 803). This determination, for example, can be made by having the second storage subsystem 6 reference the copy group information 421 that exists in the second storage subsystem 6.

When an affirmative determination result is obtained in Step 803 (Step 803: YES), the first storage subsystem 5 sends a restoration interrupt command to the second storage subsystem 6 (Step 804). Next, the first storage subsystem 5 sends the difference information 13 of the copy group targeted for the resynch operation to the second storage subsystem 6 (Step 805). Then, after the transmission of the difference information 13 is over, the first storage subsystem 5 sends a restoration restart command to the second storage subsystem 6 (Step 806).

Furthermore, when a negative determination result is obtained in Step 801 (Step 801: NO), the first storage subsystem 5 can notify the computer 1 of an error and terminate processing (Step 807). Further, when an affirmative determination result is obtained in Step 802 (Step 802: YES), and a negative determination result is obtained in Step 803 (Step 803: NO), the first storage subsystem 5 can send the difference information 13 to the second storage subsystem 6 and terminate processing (Step 808).

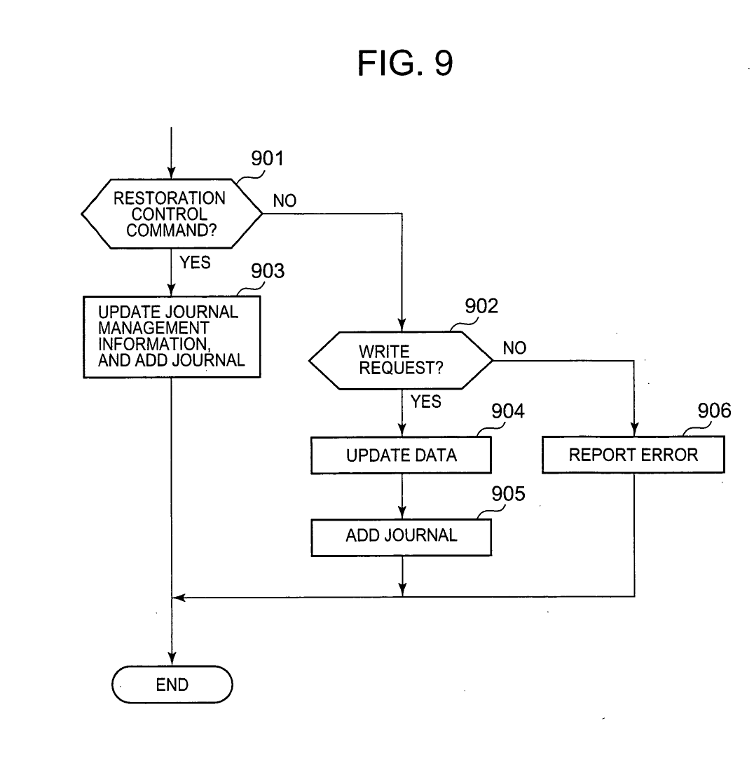

FIG. 9 is an example of a flowchart of processing carried out by the second storage subsystem 6 upon receiving information from the first storage subsystem 5.

The second storage subsystem 6 makes a determination as to whether or not the information received from the first storage subsystem 5 is a restoration control command 16, and when it is not, makes a determination as to whether or not this information is a write request (Step 901, Step 902).

If the received information is a restoration control command 16, the second storage subsystem 6 sets the flag 702 for the journal 320 to “restoration control”, sets the code (either “restart” or “interrupt”) specified by this command 16 in the control code 721, updates the state 604 of the journal management information 422, and adds the journal 320 to the journal storage device 14 (Step 903).

If the information received from the first storage subsystem 5 is a write request, the second storage subsystem 6 writes the data of inside this write request to the SP-storage device 11SP (Step 904). The second storage subsystem 6 also creates a journal of the data written to the SP-storage device 11SP, and adds the journal 320 to the journal storage device 14 (Step 905).

Furthermore, if the information received from the first storage subsystem 5 is neither a restoration control command nor a write request, the second storage subsystem 6 can notify the first storage subsystem 5 of an error (Step 906).

Thus, each time a restoration control command or write request is received, a journal 320 is added to the first journal storage device 14. There are cases when a write request comprises difference data. That is, when a plurality of difference data (data groups contained in difference information 13) is received from the first storage subsystem 5, difference journals, which accord with the order in which the respective difference data were received, are generated, and stored in the first journal storage device 14. The respective journals inside the first journal storage device 14 are transferred to the third storage subsystem 7, and stored in the second journal storage device 15. The third storage subsystem 7 can acquire a journal from the second journal storage device 15, and restore the data inside this journal to the S-storage device 12S.

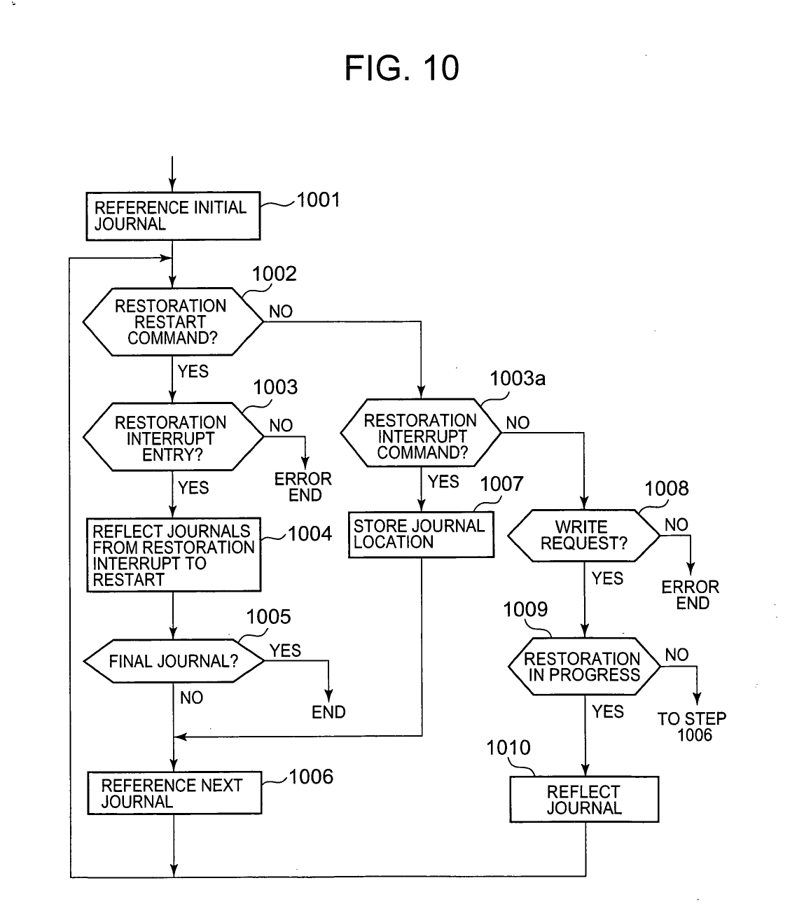

FIG. 10 shows an example of a flowchart of a restoration implemented by the third storage subsystem 7.

The third storage subsystem 7 references the journal 320 having the most recent time of the journal group in the second journal storage device 15 (Step 1001).

When the third storage subsystem 7 references the flag 702 and data 704 in a journal 320, and determines that the referenced journal 320 is related to a restoration interrupt command (Step 1002; NO; Step 1003a: YES), it stores the location of this journal 320 (for example, its logical block address), and interrupts the implementation of restoration (Step 1007). When implementation of restoration is interrupted, the third storage subsystem 7 commences exclusive control of access to the S-storage device 12S from the computer 2.

Next, the third storage subsystem 7 references the journal 320 having the next most recent time (Step 1006). When the third storage subsystem 7 determines that this journal 320 is related to a write request (Step 1002: NO; Step 1003a: NO; Step 1008: YES), if restoration is being interrupted (Step 1009: NO), it references the journal 320 with the next most recent time (Step 1006). Further, if restoration is not being interrupted, the third storage subsystem 7 writes the data inside the journal 320 to the S-storage device 12S.

When the third storage subsystem 7 determines that the referenced journal 320 is related to a restoration restart command (Step 1002; YES), it sequentially restores the journal group, which exists between this journal 320 and the location stored in Step 1007, that is, it sequentially restores the difference data group of inside the difference journal group to the S-storage device 12S (Step 1003: YES; Step 1004). When the difference data group is finished being restored, the interruption of restoration can be cancelled. Exclusive control can also be halted. Furthermore, when the location stored in Step 1007 cannot be found, an error can be reported.

If unreferenced journals exist (Step 1005: NO), the third storage subsystem 7 can carry out Step 1006, and if no unreferenced journals exist, it can terminate processing.

According to the above-mentioned embodiment, the first storage subsystem 5 sends a restoration interrupt command and a restoration restart command before and after the transmission of difference data, and controls restoration on the basis of these commands. This makes it possible to increase the likelihood of S-storage device 12S data being updated in the order in which data in the P-storage device 10P is updated, without the need for a user to perform a complex operation.

Further, in the above-mentioned embodiment, the data inside a plurality of journals need not be sequentially restored, but a plurality of difference data corresponding to a plurality of difference journals is restored sequentially. By so doing, it should be possible to shorten the length of time during which orderability in the S-storage device 12S is not guaranteed.

Further, in the above-mentioned embodiment, while a plurality of difference data is being restored, exclusive control is carried out such that the S-storage device 12S is not accessed. This makes it possible to prevent access to the S-storage device 12S while orderability in the S-storage device 12S is not guaranteed.

The foregoing description of an embodiment of the present invention has been provided for the purpose of illustration and description. It is not intended to limit the scope of the invention solely to this embodiment. The present invention can be implemented via a variety of other aspects as well.

1. A storage control method performed by a storage system, comprising a first storage subsystem; a second storage subsystem communicatively connected to the first storage subsystem; and a third storage subsystem communicatively connected to the second storage subsystem, wherein
the first storage subsystem comprises a first storage device, and is communicatively connected to an external device that exists outside the storage system;
the second storage subsystem comprises a second storage device, and a first journal storage device capable of storing a journal group;
the third storage subsystem comprises a third storage device, and a second journal storage device; and
environment is such that data written to the first storage device is transferred from the first storage subsystem to the second storage subsystem and written to the second storage device, and data written to the second storage device is transferred from the second storage subsystem to the third storage subsystem and written to the third storage device,
the storage control method comprising:
a step in which the first storage subsystem, when data written to the first storage device is not sent to the second storage subsystem, and new data is written to the first storage device, holds the newly written data as difference data, which is the difference between the data group inside the first storage device and the data group inside the second storage device, and when a difference data group comprising one or more difference data is sent to the second storage subsystem, sends a first information and a second information to the second storage subsystem such that the difference data group is interposed therebetween;
a step in which the second storage subsystem receives the first information, the difference data group, and the second information, writes the received difference data group to the second storage device, writes a difference journal group, which is one or more journals comprising the difference data group, to the first journal storage device, and sends the first information, the difference journal group, and the second information to the third storage subsystem;
a step in which the third storage subsystem receives the first information, the difference journal group, and the second information, writes the difference journal group to the second journal storage device, and, on the basis of the first information and the second information, writes the difference data group, which is included in the difference journal group inside the second journal storage device, to the third storage device.

2. The storage control method according to claim 1, wherein the third storage subsystem performs exclusive control, such that the third storage device is not accessed by either the external device or another external device, at the least while the difference data group inside the difference journal group is being written to the third storage device.

3. The storage control method according to claim 1, wherein
the first storage subsystem sends the first information, the difference data group, and the second information, in that order, to the second storage subsystem;
the second storage subsystem creates a journal group, which represents the order of the first information, the difference journal group, and the second information; and
the third storage subsystem, based on the journal group, recognizes the first information prior to recognizing the difference journal group and the second information.

4. The storage control method according to claim 3, wherein the third storage subsystem, upon recognizing the first information, searches for the second information, which exists separate from the difference journal group, and upon finding the second information, continuously writes the difference data group inside the difference journal group to the third storage device, without a substantial lapse of time.

5. The storage control method according to claim 1, wherein the first storage subsystem comprises a difference bitmap having a plurality of bits respectively corresponding to a plurality of storage areas of the first storage device, and is constituted such that, when data is written to a certain storage area of the first storage device, a bit corresponding to the certain storage area is updated, and when new data is again written to the certain storage area, the updated bit of the certain storage area is not updated.

6. The storage control method according to claim 1, wherein, the case where data written to the first storage device is not sent to the second storage subsystem is either a case where communication is not possible between the first storage subsystem and the second storage subsystem, or a case where the state of a copy group comprising the first storage device and the second storage device is changed to a prescribed state.

7. The storage control method according to claim 1, in the environment, comprising:
a step in which the first storage subsystem receives data from the external device, writes the received data to the first storage device, and sends the data, which is written to the first storage device, to the second storage subsystem;
a step in which the second storage subsystem receives data from the first storage subsystem, writes the received data to the second storage device, writes a journal, which comprises the received data and the order in which the received data is written to the second storage device, to the first journal storage device, and sends the respective journals of the journal group inside the first journal storage device to the third storage subsystem; and
a step in which the third storage subsystem receives the respective journals from the second storage subsystem, writes the received respective journals to the second journal storage device, acquires the journals, in order from the most recent to the oldest, from among the journal group inside the second journal storage device, and writes the data inside the acquired journals to the third storage device.

8. A storage system, comprising:
a first storage subsystem;
a second storage subsystem communicatively connected to the first storage subsystem; and
a third storage subsystem communicatively connected to the second storage subsystem,
wherein the first storage subsystem comprises a first controller and a first storage device, and is communicatively connected to an external device that exists outside of the storage system;
the second storage subsystem comprises a second controller, a second storage device, and a first journal storage device capable of storing a journal group;
the third storage subsystem comprises a third controller, a third storage device, and a second journal storage device; and
environment is such that data written to the first storage device is transferred from the first storage subsystem to the second storage subsystem and written to the second storage device, and data written to the second storage device is transferred from the second storage subsystem to the third storage subsystem and written to the third storage device,
wherein the first controller, when data written to the first storage device is not sent to the second storage subsystem, and new data is written to the first storage device, holds the newly written data as difference data, which is the difference between the data group inside the first storage device and the data group inside the second storage device, and when a difference data group comprising one or more difference data is sent to the second storage subsystem, sends a first information and a second information to the second storage subsystem such that the difference data group is interposed therebetween;
the second controller receives the first information, the difference data group, and the second information, writes the received difference data group to the second storage device, writes a difference journal group, which is one or more journals comprising the difference data group, to the first journal storage device, and sends the first information, the difference journal group, and the second information to the third storage subsystem; and
the third controller receives the first information, the difference journal group, and the second information, writes the difference journal group to the second journal storage device, and, on the basis of the first information and the second information, writes the difference data group, which is included in the difference journal group inside the second journal storage device, to the third storage device.

9. A storage subsystem in a storage system, the storage system comprising another storage subsystem and a storage system,
the storage subsystem being communicatively connected to an external device that exists outside the storage system, and comprising:
a controller; and
a storage device,
wherein the controller receives data from the external device, writes the received data to the first storage device, and sends the data written to the first storage device to the second storage subsystem, whereby the data is written to another storage device of the other storage subsystem, and
when data written to the storage device is not sent to the second storage subsystem, and new data is written to the storage device, the controller holds the newly written data as difference data, which is the difference between a data group inside the storage device and a data group inside the other storage device, and when a difference data group comprising one or more difference data is sent to the other storage subsystem, sends a first information and a second information to the other storage subsystem such that the difference data group is interposed therebetween.

10. The storage subsystem according to claim 9, wherein the storage subsystem is the first storage subsystem, which is included in the storage system.

11. A storage subsystem in a storage system, the storage system comprising another storage subsystem and a storage system,
the storage subsystem comprising:
a controller;
a storage device; and
a journal storage device capable of storing a journal group,
wherein the controller is constituted so as to receive journals from another storage subsystem, write the received journals to the journal storage device, acquire the journals, in order from the most recent to the oldest, from among the journal group inside the journal storage device, and write the data inside the acquired journals to the storage device, and when the controller receives a first information and a second information, which have been sent such that the journal group is interposed therebetween and recognizes the first information, the controller writes, on the basis of the first information and the second information, a certain data group, which is included in the certain journal group inside the journal storage device, to the storage device.

12. The storage subsystem according to claim 11, wherein the storage subsystem is the third storage subsystem, which is included in the storage system.

13. A storage control method performed by a storage system, which comprises a first storage subsystem; a second storage subsystem communicatively connected to the first storage subsystem; and a third storage subsystem communicatively connected to the second storage subsystem, wherein
the first storage subsystem comprises a first storage device, and is communicatively connected to an external device that exists outside the storage system;
the second storage subsystem comprises a second storage device, and a first journal storage device capable of storing a journal group; and
the third storage subsystem comprises a third storage device, and a second journal storage device;
the storage control method comprising:
a step in which the first storage subsystem receives data from the external device, writes the received data to the first storage device, and sends the data, which is written to the first storage device, to the second storage subsystem;
a step in which the second storage subsystem receives data from the first storage subsystem, writes the received data to the second storage device, writes a journal, which comprises the received data, and the order in which the received data is written to the first journal storage device, and sends the respective journals of the journal group inside the first journal storage device to the third storage subsystem;
a step in which the third storage subsystem receives the respective journals from the second storage subsystem, writes the received respective journals to the second journal storage device, acquires journals, in order from the most recent to the oldest, from among the journal group inside the second journal storage device, and writes the data inside the acquired journals to the third storage device;
a step in which the first storage subsystem, when data written to the first storage device is not sent to the second storage subsystem and new data is written to the first storage device, holds the newly written data as difference data, which is the difference between a data group inside the first storage device and a data group inside the second storage device, and when a difference data group comprising one or more difference data is sent to the second storage subsystem, sends to the second storage subsystem a first information and a second information, such that the difference data group is interposed therebetween;
a step in which the second storage subsystem receives the first information, the difference data group, and the second information, writes the received difference data group to the second storage device, writes a journal group which represents the order of the first information, the difference journal group which is one or more journals comprising the difference data group, and the second information, to the first journal storage device, and sends the journal group to the third storage subsystem; and
a step in which the third storage subsystem receives the journal group, writes the received journal group, and, on the basis of the journal group, recognizes the first information prior to recognizing the difference journal group and the second information, and upon recognizing the first information, searches for the second information that exists separate from the difference journal group, and upon finding the second information, continuously writes the difference data group inside the difference journal group interposed between the first information and the second information to the third storage device, without a substantial lapse of time.

14. The storage control method according to claim 13, wherein the third storage subsystem performs exclusive control, such that the third storage device is not accessed by either the external device or another external device, at the least while the difference data group of inside the difference journal group is being written to the third storage device.
